(19) United States
(12) Patent Application Publication
(10) Pub. No.: US 2024/0380492 A1
(43) Pub. Date: Nov. 14, 2024

(54) SILICON PHOTONICS TRANSMITTER AND METHOD THEREFOR

(71) Applicant: Electronics and Telecommunications Research Institute, Daejeon (KR)

(72) Inventors: Sanghwa YOO, Daejeon (KR); Heuk PARK, Daejeon (KR); Joon Ki LEE, Sejong-si (KR)

(21) Appl. No.: 18/660,145

(22) Filed: May 9, 2024

(30) Foreign Application Priority Data
May 9, 2023 (KR) 10-2023-0060073

(51) Int. Cl. H04B 10/50; G02F 1/21; G02F 1/225; H04B 10/548

(52) U.S. Cl. CPC H04B 10/505; G02F 1/212; G02F 1/2252; H04B 10/548

(57) ABSTRACT

A silicon photonics transmitter and a method therefor are disclosed. The silicon photonics optical transmitter includes a Mach-Zehnder modulator, a plurality of optical couplers, a plurality of photodetectors, a monitor configured to measure an input optical power based on a sum of photocurrents or photovoltages corresponding to the plurality of photodetectors, and a modulator controller configured to control a voltage supplied to the Mach-Zehnder modulator based on a difference between the photocurrents or the photovoltages corresponding to the plurality of photodetectors.

### CROSS-REFERENCE TO RELATED APPLICATION

The present application claims priority to Korean Patent Application No. 10-2023-0060073, filed on May 9, 2023, the disclosures of which are incorporated by reference herein in their entireties.

### TECHNICAL FIELD

The present disclosure relates to a silicon photonics transmitter and a method therefor. More specifically, the present disclosure relates to a silicon photonics optical transmitter including an optical power monitoring device and operation method thereof.

### BACKGROUND

The statements in this section merely provide background information related to the present disclosure and do not necessarily constitute prior art.

With the development of the Internet, technologies have been developed to transmit more data faster. However, in the case of a data transmission method using electrons, not only is there a limit to the transmission speed, but as the transmission speed increases, the loss of the electrical signal increases, greatly reducing the transmission distance.

Optical communications is a method to solve the problems of data transmission methods using electronics. In optical communications, data is transmitted using light instead of electrons. With optical communication, large amounts of data can be transmitted quickly.

Conventional modules for optical communications are manufactured by assembling various individual photonics devices. Optical communication modules manufactured using such a method have problems in that the cost is high and it is difficult to miniaturize the equipment and increase transmission capacity.

Silicon photonics technology integrates various photonics devices into a single chip using a commercial CMOS (complementary metal-oxide-semiconductor) process. The silicon photonics technology enables the mass production of devices for optical communications, which results in low-cost, miniaturized, and high-capacity optical communication modules. Silicon photonics optical transmission devices are currently being considered as key devices to cope with the exponentially increasing data center traffic and communication traffic.

In order to increase the production efficiency of silicon photonics chips, it is necessary to select good devices among the produced silicon photonics chips. Good devices, among the produced silicon photonics chips, are determined by whether the light source operates normally when a light source is combined with the silicon photonics chip and whether light alignment between the light source and the silicon photonics chip is properly achieved. The normal operation and optical alignment of the light source can be determined by monitoring the optical power of the silicon photonics chip.

A conventional device for monitoring the optical power of silicon photonics chip has a specific structure or uses only one photodetector per optical modulator, so the procedure for finding the quadrature point is complicated.

### SUMMARY

According to at least one embodiment, the present disclosure provides a silicon photonics optical transmitter including a Mach-Zehnder modulator, a plurality of optical couplers, a plurality of photodetectors, a plurality of analog-digital converters, a monitor and a modulator controller. The Mach-Zehnder modulator is configured to receive light from a light source and modulate the received light. The plurality of optical couplers is configured to receive the modulated light output from the Mach-Zehnder modulator and tap the modulated light at a constant ratio. The plurality of photodetectors is configured to receive light tapped by the plurality of optical couplers and output photocurrents. The plurality of analog-digital converters is configured to convert the photocurrents output from the plurality of photodetectors to digital signals. The monitor is configured to measure an input optical power based on a sum of photocurrents or photovoltages corresponding to the plurality of photodetectors. The modulator controller is configured to control a voltage supplied to the Mach-Zehnder modulator based on a difference between the photocurrents or the photovoltages corresponding to the plurality of photodetectors

According to at least one embodiment, the present disclosure provides a silicon photonics optical transmitter including a Mach-Zehnder modulator having a 2×2 optical coupler, a plurality of optical couplers, a plurality of photodetectors, a plurality of analog-digital converters, an adder, a monitor, a subtractor, and a modulator controller. The Mach-Zehnder modulator is configured to receive light from a light source and modulate the received light. The plurality of optical couplers is configured to receive the modulated light output from the Mach-Zehnder modulator and tap the modulated light at a constant ratio. The plurality of photodetectors is configured to receive light tapped by the plurality of optical couplers and output photocurrents. The plurality of analog-digital converters is configured to convert the photocurrents output from the plurality of photodetectors to digital signals. The adder is configured to calculate a sum of the digital signals converted by the plurality of analog-digital converters to represent optical power. The monitor configured to monitor an optical power based on the calculated sum. The subtractor is configured to calculate a difference between the digital signals converted by the plurality of analog-digital converters. The modulator controller is configured to control a voltage supplied to the Mach-Zehnder modulator based on the calculated difference.

According to another embodiment, the present disclosure provides a silicon photonics optical transmitter including a Mach-Zehnder modulator having a 2×2 optical coupler, a plurality of optical couplers, a plurality of photodetectors, a plurality of analog-digital converters, a monitor, and a modulator controller. The Mach-Zehnder modulator is configured to receive light from a light source and modulate the received light. The plurality of optical couplers is configured to receive the modulated light output from the Mach-Zehnder modulator and tap the modulated light at a constant ratio. The plurality of photodetectors is configured to receive light tapped by the plurality of optical couplers and output photocurrents, wherein a cathode of a first photodetector, selected from among the plurality of photodetectors, is connected to an anode of a second photodetector, selected from among the plurality of photodetectors; and wherein cathodes or anodes of at least two third photodetectors, selected from among remaining photodetectors other than the first photodetector and the second photodetector, are connected to each other. The plurality of analog-digital converters is configured to convert the photocurrents output from the plurality of photodetectors to digital signals. The monitor configured to monitor an optical power based on the digital signals. The modulator controller is configured to control a voltage supplied to the Mach-Zehnder modulator based on the digital signals.

According to yet another embodiment, the present disclosure provides a method for a silicon photonics optical transmitter. The method includes a modulating process of receiving light from a light source and shifting a phase of the light, outputting the light modulated through the modulation process using a 2×2 optical coupler, tapping the light output from the 2×2 optical coupler into a first portion and a second portion at a constant ratio, outputting photocurrents using the first portion of the tapped light, converting the photocurrents from analog signals to digital signals, adding the digital signals together and monitoring the results, calculating a difference between the digital signals, and controlling the modulating process using the result of the calculating.

### BRIEF DESCRIPTION OF THE DRAWINGS

FIG. 1 is a schematic block diagram of a silicon photonics optical transmitter according to one embodiment of the present disclosure.

FIG. 2 is a schematic block diagram of a Mach-Zehnder modulator according to one embodiment of the present disclosure.

FIG. 3 is a graph showing photocurrent output by a photodetector according to one embodiment of the present disclosure.

FIGS. 4 and 5 illustrate examples of the silicon photonics optical transmitter according to embodiments of the present disclosure.

FIG. 6 illustrates an example of a connection between the photodetectors according to one embodiment of the present disclosure.

FIG. 7 is a flowchart of a method for monitoring a light source according to one embodiment of the present disclosure.

FIG. 8 is a flowchart of a method for controlling the voltage of the Mach-Zehnder modulator according to one embodiment of the present disclosure.

FIGS. 9A-9E illustrate a variety of examples of a silicon photonics optical transmitter having an optical power monitoring device, according to embodiments of the present disclosure.

FIGS. 10A-10E illustrate a variety of other examples of a silicon photonics optical transmitter having an optical power monitoring device, according to embodiments of the present disclosure.

### DETAILED DESCRIPTION

The present disclosure may provide a silicon photonics optical transmitter capable of monitoring the optical power output from a light source, determining whether the light source is operating normally and/or determining whether the light source and the silicon photonics chip are optically aligned, regardless of the bias voltage of a Mach-Zehnder modulator and the structure of the silicon photonics.

Further, the present disclosure may provide a silicon photonics optical transmitter that can monitor and control the operation of an optical modulator and has a simple procedure for finding a quadrature point.

The features of the present disclosure are not limited to the features mentioned above, and other features not mentioned will be clearly understood by one of ordinary skill in the art from the description below.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure and is not intended to represent the only embodiments in which the present disclosure may be practiced.

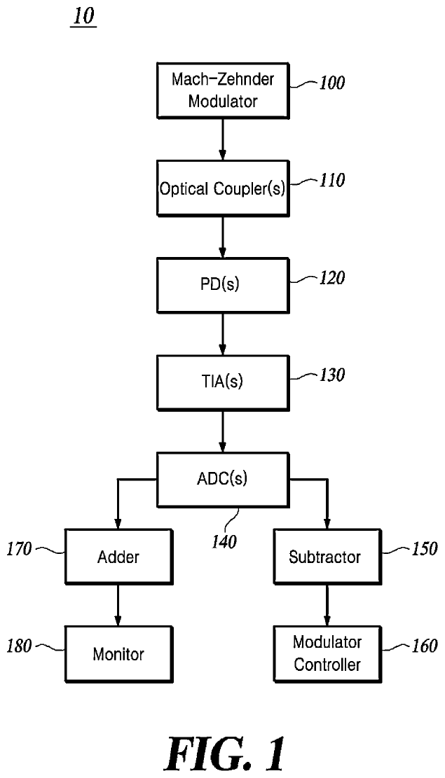

FIG. 1 is a schematic block diagram of a silicon photonics optical transmitter 10 according to one embodiment of the present disclosure.

Referring to FIG. 1, the silicon photonics optical transmitter 10 may include all or some of a Mach-Zehnder modulator 100, an optical coupler 110, a photodetector (PD) 120, a transimpedence amplifier (TIA) 130, an analog-digital converter (ADC) 140, a subtractor 150, a modulator controller 160, an adder 170, and a monitor 180.

The silicon photonics optical transmitter 10 according to the present disclosure may be formed on a silicon photonics chip.

The Mach-Zehnder modulator 100 may modulate the input light by phase shifting it.

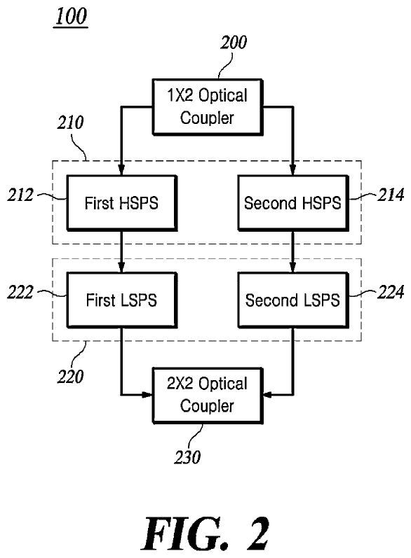

FIG. 2 is a schematic block diagram of the Mach-Zehnder modulator 100 according to one embodiment of the present disclosure.

The Mach-Zehnder modulator 100 may include all or some of a 1×2 optical coupler 200, a plurality of high speed phase shifters (HSPSs) 210, a plurality of low speed phase shifters (LSPSs) 220, and a 2×2 optical coupler 230.

The 1×2 optical coupler 200 may tap the light input to the Mach-Zehnder modulator 100.

The HSPS 210 may modulate the phase of the input light. The HSPSs 210 may modulate the phase of light by receiving a high-frequency RF (radio frequency) electrical signal.

The LSPSs 220 may modulate the phase of the light modulated by the HSPSs 210 once more. The LSPSs 220 may modulate the phase of light by receiving a DC electrical signal. In this case, a first LSPS 222 may modulate the light modulated by a first HSPS 212 once more, and a second LSPS 224 may modulate the light modulated by a second HSPS 214 once more.

The 2×2 optical coupler 230 may combine phase-modulated light received from the LSPSs 220, and output combined light.

The Mach-Zehnder modulator 100 of the present disclosure may include, for example, two HSPSs 212, 214, and two LSPSs 222, 224.

The characteristics of light output from the Mach-Zehnder modulator 100 are as shown in Equation 1.

$${T}_{1} = \frac{1 + cos ϕ}{2} , \qquad ( Equation 1 )$$

$${T}_{2} = \frac{1 - cos ϕ}{2}$$

Here, T1 is a variable representing the characteristics of the light output from the first LSPS 222, T2 is the characteristic of the light output from the second LSPS 224, and ϕ is a variable representing the phase shift of the light.

The optical coupler 110 may tap the input light. In this case, the optical coupler 110 may be a 1×2 optical coupler. The optical coupler 110 may tap the input light at a certain ratio. For example, the optical coupler 110 may tap the input light at a ratio of 10:90. The ratio of 10:90 is just an example, and the ratio at which the optical coupler 110 taps the input light is not limited to this.

The silicon photonics optical transmitter of the present disclosure may include a plurality of optical couplers 110. The optical coupler 110 may be a 1×2 optical coupler or a 2×2 optical coupler.

When light is input, the photodetector 120 may output a photocurrent with an intensity proportional to the input optical power. The silicon photonics optical transmitter 10 of the present disclosure may include at least two photodetectors 120.

Each TIA 130 may receive the photocurrent output from each photodetector 120 and converts it into a photovoltage.

Each analog-digital converter 140 may convert the photocurrent input from each photodetector 120 or the photovoltage input from each TIA 130 into a digital signal. One analog-digital converter 140 may output the converted digital signal to the subtractor 150 and the adder 170, respectively. For example, in the case of the silicon photonics optical transmitter 10 comprising two analog-digital converters 140, a first analog-digital converter may output a first digital signal to the subtractor 150 and the adder 170, and a second analog-digital converter may output a second digital signal to the subtractor 150 and the adder 170. In this case, the first digital signal and the second digital signal may be a digital signal converted from photocurrent or a digital signal converted from photovoltage.

The subtractor 150 may receive digital signals output from the plurality of analog-digital converters 140 and calculate the difference between the photocurrents or photovoltages converted to digital signals. For example, the subtractor 150 may calculate the difference between the first digital signal and the second digital signal.

The modulator controller 160 may control the Mach-Zehnder modulator 100 using the difference between the photocurrents or photovoltages converted to digital signals calculated by the subtractor 150. For example, the modulator controller 160 may control the Mach-Zehnder modulator 100 until the difference between the photocurrents or photovoltages converted to digital signals calculated by the subtractor 150 becomes 0. The point at which the difference between the photocurrents or photovoltages converted to digital signals becomes 0 is called a quadrature point 330. According to one embodiment of the present disclosure, the modulator controller 160 may control the Mach-Zehnder modulator 100 by controlling the LSPS 220 of the Mach-Zehnder modulator 100.

The adder 170 may receive a plurality of digital signals output from the plurality of analog-digital converters 140, and add the photocurrents or photovoltages converted to digital signals. For example, the adder 170 may add the first digital signal and the second digital signal.

The sum of the photocurrents or photovoltages is constant regardless of the change in the bias voltage of the Mach-Zehnder modulator 100. The sum of the photocurrents or photovoltages is proportional only to the optical power input to the silicon photonics optical transmitter 10. Therefore, the optical power can be measured simply by adding the photocurrents or photovoltages converted to digital signals using the adder 170.

The monitor 180 may monitor the sum of the photocurrents or photovoltages added by the adder 170. The monitor 180 can measure optical power by monitoring the sum of the photocurrents or photovoltages and determine whether the light source and the silicon photonics chip are optically aligned.

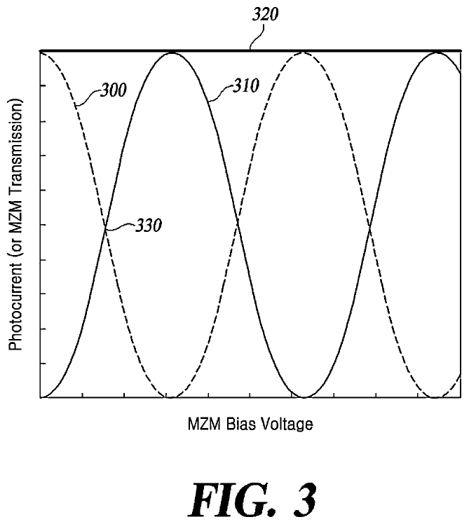

FIG. 3 is a graph showing the photocurrent output by the photodetector 120 according to one embodiment of the present disclosure.

Referring to FIG. 3, two photocurrents 300 and 310 may be output from two photodetectors 120. A first photocurrent 300 may be output from a first photodetector, and a second photocurrent 310 may be output from a second photodetector.

When the same light is continuously incident on the Mach-Zehnder modulator 100, the sum 320 of the first photocurrent 300 and the second photocurrent 310 is constant. Even if the bias voltage of the Mach-Zehnder modulator 100 shown in the horizontal direction changes, the sum 320 of the first photocurrent 300 and the second photocurrent 310 is constant. Here, the bias voltage may refer to the voltage of one of the LSPSs 220 whose voltage is not fixed while the voltage of another one of the LSPSs 220 is fixed. For example, when the voltage of the first LSPS 222 is fixed, the voltage of the second LSPS 224 is used as the bias voltage.

Even if the bias voltage of the Mach-Zehnder modulator 100 changes, the sum 320 of the first photocurrent 300 and the second photocurrent 310 is constant, and the value of the sum 320 of the first photocurrent 300 and the second photocurrent 320 changes only depending on the change in light incident on the Mach-Zehnder modulator 100. Therefore, it is possible to determine whether the light source and the silicon photonics chip are optically aligned by measuring the optical power according to the magnitude of the photocurrent output by the adder 170.

When the bias voltage of the Mach-Zehnder modulator 100 is varied, the values of the first photocurrent 300 and the second photocurrent 310 change. The subtractor 150 may calculate the difference between the first photocurrent 300 and the second photocurrent 310. The point at which the first photocurrent 300 and the second photocurrent 310 have the same value may be referred to as the quadrature point 330. Using only the result of the subtractor 150, the quadrature point 330 can be simply found, and the bias voltage of the Mach-Zehnder modulator 100 can be controlled to be the phase orthogonal point 330 using the modulator controller 160.

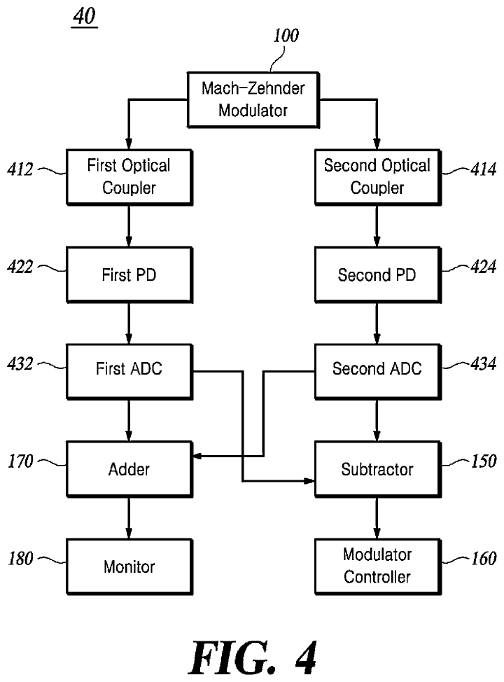

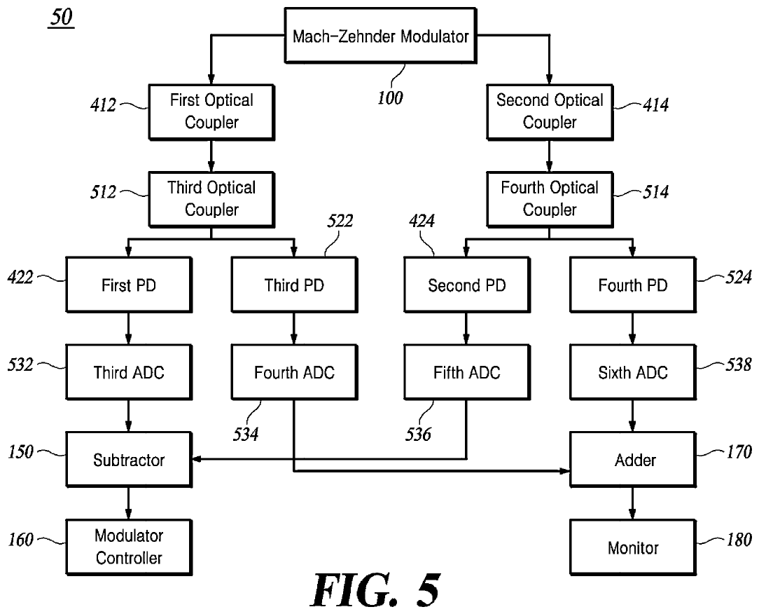

FIGS. 4 and 5 illustrate examples of the silicon photonics optical transmitter according to embodiments of the present disclosure.

Referring to FIG. 4, the silicon photonics optical transmitter 40 may include all or some of a Mach-Zehnder modulator 100, two optical couplers 412, 414, two photodetectors 422, 424, and two analog-digital converters 432, 434, a subtractor 150, a modulator controller 160, and an adder 170.

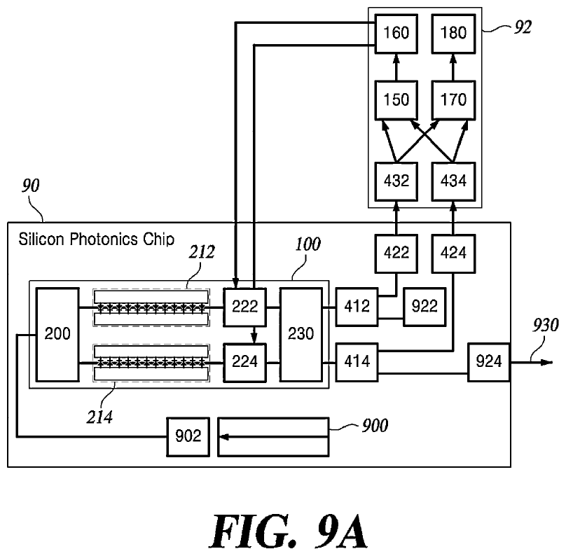

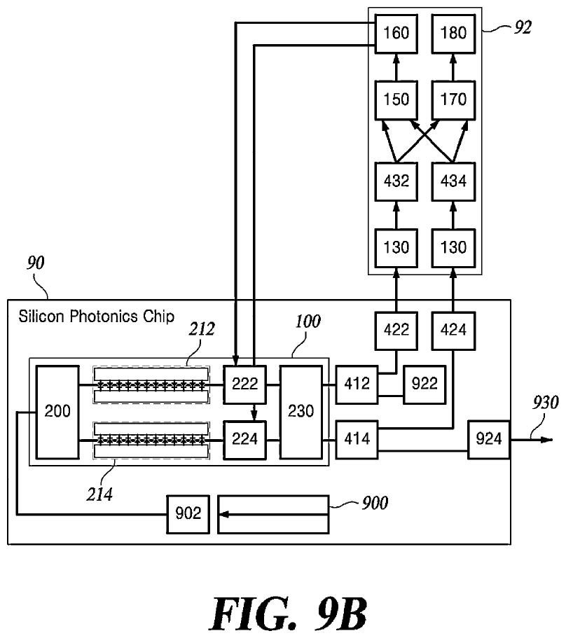

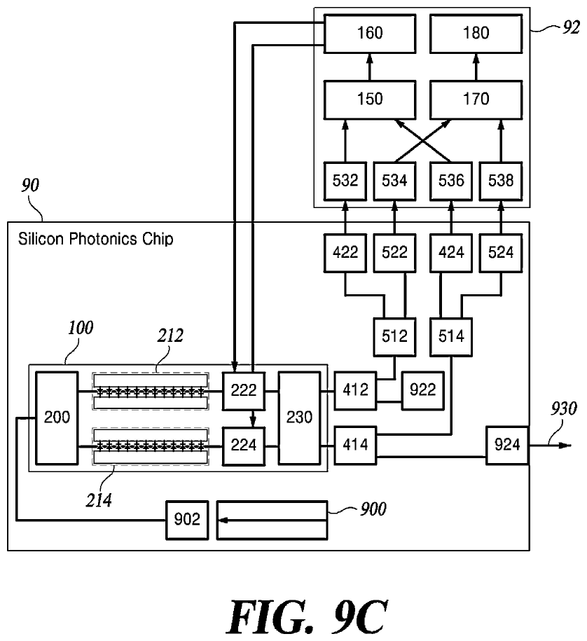

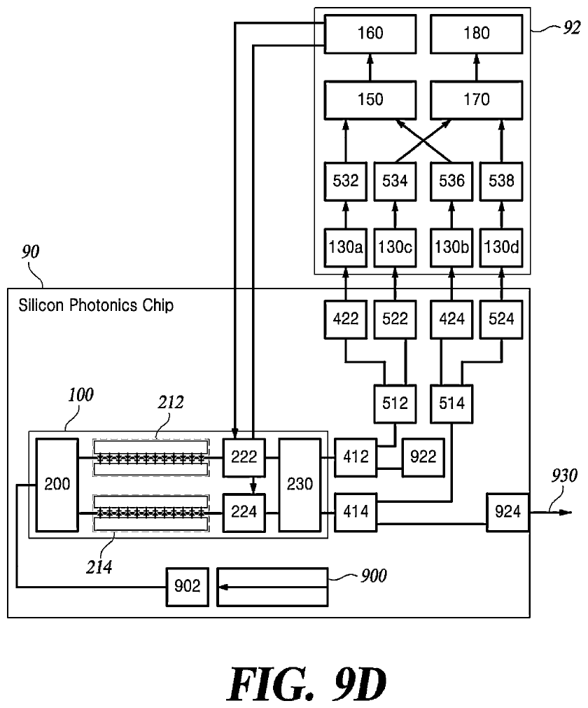

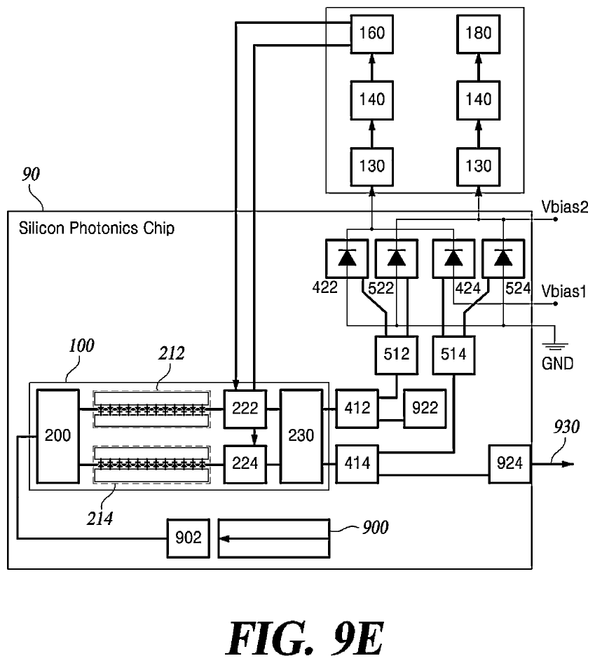

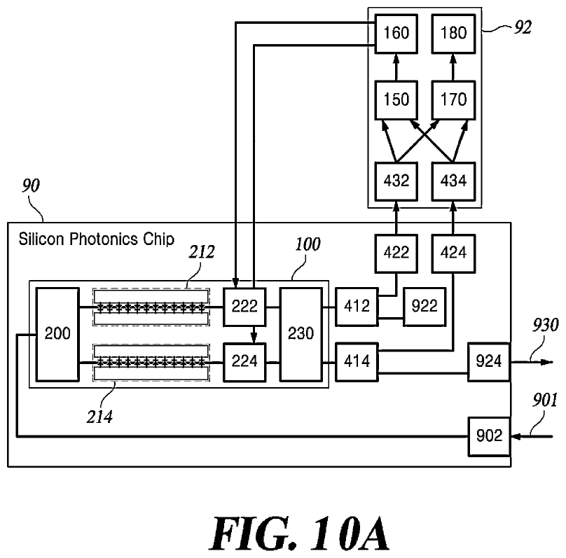

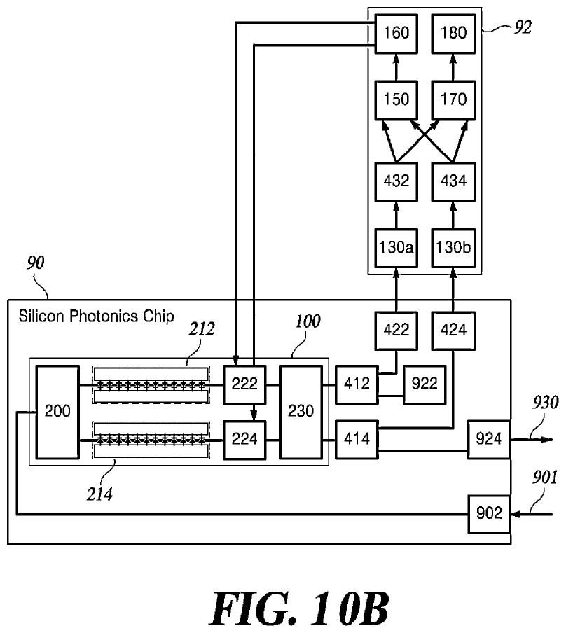

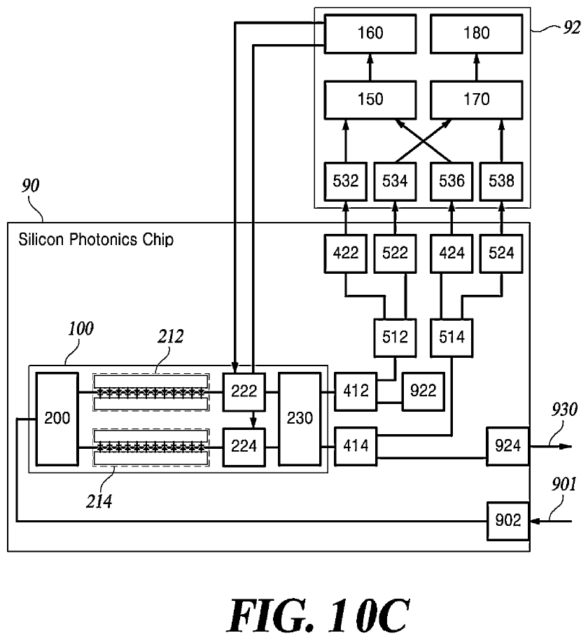

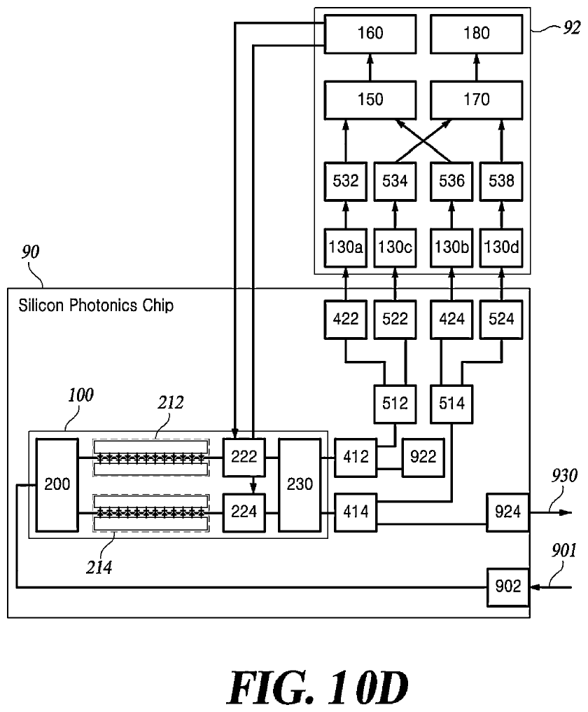

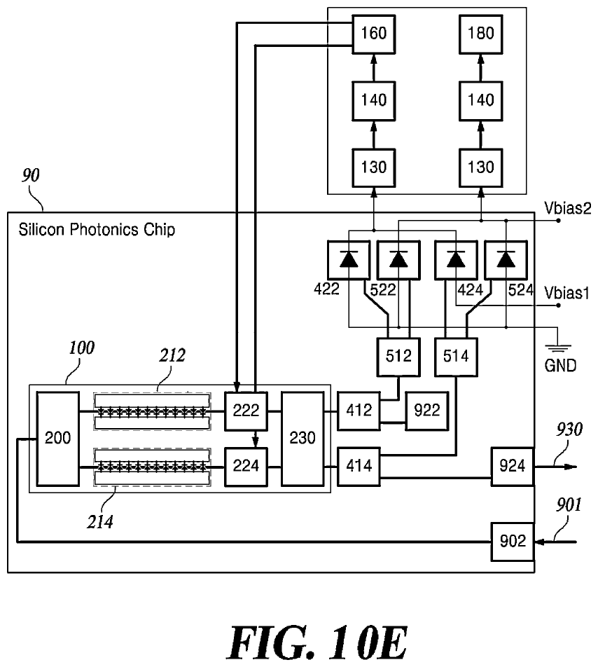

In describing the silicon photonics optical transmitter 40 according to some embodiments, FIGS. 9A, 9B, 10A, and/or 10B may be referred to together with FIG. 4. FIG. 9A, 9B, 10A, or 10B, illustrate various examples of a silicon photonics optical transmitter 40 including an optical power monitoring device 92. Specifically, FIGS. 9A and 9B show various examples of a silicon photonics optical transmitter 40 with a light source 900 provided on a silicon photonics chip 90 and FIGS. 10A and 10B show various examples of a silicon photonics optical transmitter 40 in which light is input from outside the silicon photonics chip 90. At least some components of the silicon photonics optical transmitter 40 may be provided on the silicon photonics chip 90, and other at least some components may be provided on the optical power monitoring device 92.

Light output from the 2×2 optical coupler 230 included in the Mach-Zehnder modulator 100 may be incident on the two optical couplers 412 and 414. The optical couplers 412 and 414 may tap the incident light at a ratio of 10:90. Light corresponding to 10% of the tapped light may be incident on the photodetectors 422 and 424. In this case, the light output from a first optical coupler 412 may be incident on a first photodetector 422, and the light output from a second optical coupler 414 may be incident on a second photodetector 424.

The photodetectors 422 and 424 may convert the incident light into photocurrent and output it.

The analog-digital converters 432 and 434 may convert the light output from the photodetectors 422 and 424 to digital signals, and input the converted digital signals to the adder 170 and the subtractor 150. In this case, each of the analog-digital converters 432 and 434 may input digital signals to both the adder 170 and the subtractor 150.

Referring to FIG. 9B or 10B, the silicon photonics optical transmitter 40 may further include two TIAs 130a and 130b. Each of the TIAs 130a and 130b may convert the photocurrent output by the photodetectors 422, 424 into a photovoltage. Each of the TIAs 130a and 130b may output the converted photovoltage to the analog-digital converters 432, 434. The analog-digital converters 432, 434 may convert the input photovoltage into a digital signal.

Referring to FIG. 5, the silicon photonics optical transmitter 50 may include all or some of a Mach-Zehnder modulator 100, four optical couplers 412, 414, 512, 514, four photodetectors 422, 424, 522, 524, four analog-digital converters 532, 534, 536, 538, a subtractor 150, a modulator controller 160, and an adder 170.

In describing the silicon photonics optical transmitter 50 according to some embodiments, FIGS. 9C, 9D, 10C, and/or 10D may be referred to together with FIG. 5. FIG. 9C, 9D, 10C, or 10D, illustrate various examples of a silicon photonics optical transmitter 50 including an optical power monitoring device 92. Specifically, FIGS. 9C and 9D show various examples of a silicon photonics optical transmitter 50 with a light source 900 provided on a silicon photonics chip 90 and FIGS. 10C and 10D show various examples of a silicon photonics optical transmitter 50 in which light is input from outside the silicon photonics chip 90. At least some components of the silicon photonics optical transmitter 50 may be provided on the silicon photonics chip 90, and other at least some components may be provided on the optical power monitoring device 92.

Light output from the 2×2 optical coupler 230 included in the Mach-Zehnder modulator 100 may be incident on a first optical coupler 412 and a second optical coupler 414. The first optical coupler 412 and the second optical coupler 414 may tap incident light at a ratio of 10:90.

Light corresponding to 10% of the tapped light may be incident on a third optical coupler 512 and a fourth optical coupler 514. The third optical coupler 512 and the fourth optical coupler 514 may tap incident light at a ratio of 50:50.

The third optical coupler 512 and the fourth optical coupler 514 may make the tapped light incident on the photodetectors 422, 424 522 and 524. In this case, one optical coupler 512 and 514 may make light incident on two photodetectors. For example, the third optical coupler 512 may make light incident on a first photodetector 422 and a third photodetector 522, and the fourth optical coupler 514 may make light incident on a second photodetector 424 and a fourth photodetector 524.

The photocurrent output from each of the photodetectors 422, 424, 522 and 524 may be input to each of the analog-digital converters 532, 534, 536 and 538. For example, the first photodetector 422 may input a photocurrent to a third analog-digital converter 532, the second photodetector 424 may input a photocurrent to a fifth analog-digital converter 536, the third photodetector 522 may input a photocurrent to a fourth analog-digital converter 534, and the fourth photodetector 524 may input a photocurrent to the sixth analog-digital converter 538.

The analog-digital converters 532, 534, 536 and 538 may convert the input photocurrent into a digital signal and output it. Each of the analog-digital converters 532, 534, 536 and 538 may convert the photocurrent into a digital signal and inputs it to the subtractor 150 or adder 170. For example, the third analog-digital converter 532 and the fifth analog-digital converter 536 may input the digital signal to the subtractor 150, and the fourth analog-digital converter 534 and the sixth analog-digital converter 536 may input the digital signal to the adder 170.

Referring to FIG. 9D or 10D, the silicon photonics optical transmitter 50 may further include four TIAs 130a to 130d. Each of the TIAs 130a to 130d may receive the photocurrent output from each photodetector 422, 424, 522, 524, and convert the input photocurrent into a photovoltage. Each of the TIAs 130a to 130d may output the converted photovoltage. Each of the analog-digital converters 532, 534, 536 and 538 may convert the photovoltage output from each of the TIAs 130a to 130d into a digital signal.

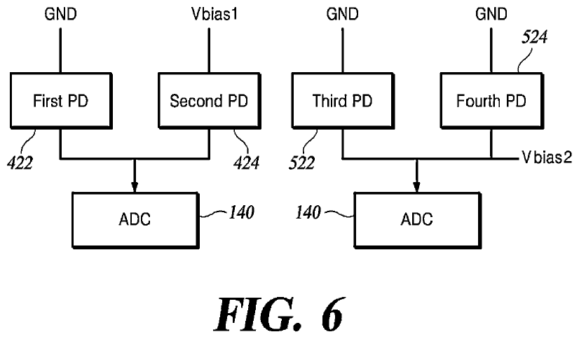

FIG. 6 illustrates an example of a connection between the photodetectors according to one embodiment of the present disclosure.

Referring to FIG. 6, the silicon photonics optical transmitters 10, 40 and/or 50 may include four photodetectors 422, 424, 522 and 524. In some embodiments, functions of the subtractor 150 and the adder 170 may be integrated into the photodetectors 422, 424, 522 and 524. That is, the silicon photonics optical transmitters 10, 40 and/or 50 may not include the subtractor 150 and the adder 170.

In describing the silicon photonics optical transmitter 10, 40 and/or 50 according to some embodiments, FIGS. 9E and/or 10E may be referred to together with FIG. 6. FIGS. 9E and 10E illustrate various examples of a silicon photonics optical transmitter including an optical power monitoring device 92 without both the subtractor 150 and the adder 170. Specifically, FIG. 9E shows an example of a silicon photonics optical transmitter with a light source 900 provided on a silicon photonics chip 90, and FIG. 10E shows another example of a silicon photonics optical transmitter in which light is input from outside the silicon photonics chip 90.

Among the four photodetectors 422, 424, 522 and 524, the cathode (or anode) of the first photodetector 422 and the anode (or cathode) of the second photodetector 424 may be connected to each other. That is, the anode of the first photodetector 422 and the cathode of the second photodetector 424 may be connected, or the cathode of the first photodetector 422 and the anode of the second photodetector 424 may be connected. In this case, the connected anode and cathode of the photodetectors 422 and 424 are connected through a metal electrode to allow current to flow.

By connecting the anodes and the cathodes of the photodetectors 422 and 424, the difference in photocurrent output from the two photodetectors can be derived without the subtractor 150. A bias is set so that a reverse voltage can be applied to the first photodetector 422 and the second photodetector 424.

Electrodes that are not connected to other photodetectors 422 and 424 may be grounded or connected to an external voltage source. For example, when the cathode of the first photodetector 422 and the anode of the second photodetector 424 are connected, the anode of the first photodetector 422 is grounded and the cathode of the second photodetector 424 is connected to an external voltage source Vbias1. Accordingly, a reverse bias is applied to the first photodetector 422 and the second photodetector 424. Among the electrodes of the first photodetector 422 and the second photodetector 424, the interconnected electrodes may be connected to the TIA 130 or the analog-digital converter 140.

The cathode (or anode) of the third photodetector 522 may be connected to the cathode (or anode) of the fourth photodetector 524. That is, the anode of the third photodetector 522 and the anode of the fourth photodetector 524 may be connected, or the cathode of the third photodetector 522 and the cathode of the fourth photodetector 524 may be connected. By connecting the anodes or the cathodes of the photodetectors 522 and 524, photocurrent can be added without the adder 170. In this case, the anodes or the cathodes of the photodetectors 522 and 524 are connected through a metal electrode to allow current to flow.

When the cathode of the third photodetector 522 and the cathode of the fourth photodetector 524 are connected, both the anode of the third photodetector 522 and the anode of the fourth photodetector 524 may be grounded. The connected electrodes of the third photodetector 522 and the fourth photodetector 524 are connected to the TIA 130 or the analog-digital converter 140. Additionally, the connected electrodes may be connected to an external voltage source Vbias2. The external voltage sources Vbias1 and Vbias2 may supply different voltages.

The monitor 180 may monitor the photocurrent formed and summed by the photodetectors 522, 524 with the anodes or cathodes connected to each other, or the photovoltage converted from the photocurrent formed and summed by the photodetectors 522, 524 through the TIA 130.

Meanwhile, referring to FIGS. 9A-10E, all or at least part of the silicon photonics optical transmitter 10, 40 and/or 50 according to the present disclosure may be formed on a silicon photonics chip 90.

The silicon photonics optical transmitter 10, 40 and/or 50 may include some or all of a waveguide, a light source 900, one or more coupling device 902 and/or 924, and an optical terminator 922.

The waveguide may allow light to travel in a certain direction. The waveguide according to the present disclosure may be a silicon waveguide (Si waveguide). The waveguide may connect the components of the silicon photonics optical transmitter and transmit light between the components. For example, the optical coupler 110 (or the optical couplers 412, 414, 512 and/or 514) may transmit light to the photodetector 120 (or the photodetectors 422, 424, 522 and/or 524) using the waveguide.

The light source 900 may generate light. The light generated by the light source 900 may be laser light. The light generated by the light source 900 may be incident on the coupling device 902.

The coupling device 902 and/or 924 may transmit light received from one component to another component. In one embodiment, the coupling device 902 may receive light generated by the light source 900 and transmit it to the waveguide. In another embodiment, the coupling device 924 may transmit light incident from the waveguide to an optical fiber 930 connected to the outside of the silicon photonics optical transmitter (or the silicon photonics chip 90). For example, when the optical coupler 110 (or the optical coupler 414) taps light at a ratio of 1:9, the coupling device 924 may receive 90% of the light from the waveguide and transmit it to the optical fiber 930 connected to the outside of the silicon photonics optical transmitter. In yet another embodiment, the coupling device 902 may receive light generated by the light source 900 outside the silicon photonics chip 90 (or outside the silicon photonics optical transmitter 10, 40 and/or 50) and transmit it to the waveguide.

The optical terminator 922 may extinguish the input light without reflection. The optical terminator 922 may receive some of the light tapped by the optical coupler 110 (or the optical coupler 412) and extinguish it. For example, when the optical coupler 110 (or the optical coupler 412) taps light at a ratio of 1:9, the optical terminator 922 may receive and extinguish 90% of the light.

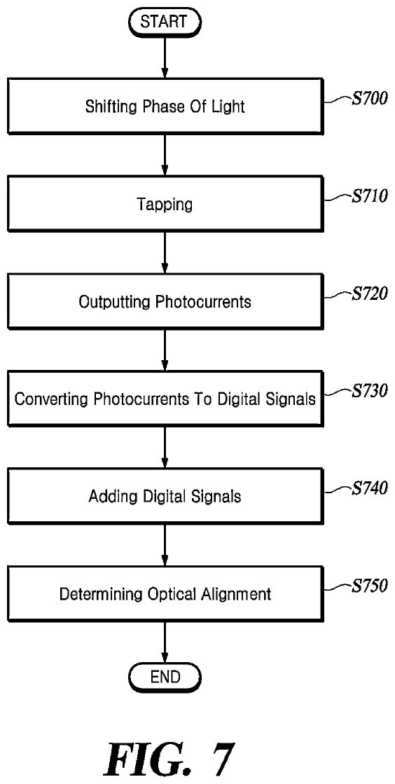

FIG. 7 is a flowchart of a method for monitoring a light source according to one embodiment of the present disclosure.

Referring to FIG. 7, when light enters the Mach-Zehnder modulator 100 from a light source through a waveguide, the Mach-Zehnder modulator 100 may shift the phase of the light. The Mach-Zehnder modulator 100 may make the phase-shifted light incident on the optical couplers 110 (S700).

The optical coupler 110 may tap the incident light (S710). Light tapped by the optical couplers 110 may be incident on the photodetectors 120.

When light is incident, the photodetectors 120 may output photocurrents proportional to the optical power of the incident light (S720).

The analog-digital converters 140 may convert the photocurrents output by the photodetectors 120 to digital signals and input the digital signals to the adder 170 (S730).

The adder 170 may add the digital signals converted by the analog-digital converters 140 (S740).

The monitor 180 may monitor the intensity of the digital signal added by the adder 170. The monitor 180 may use the intensity of the digital signal to determine whether the light source and the silicon photonics chip are optically aligned (S750).

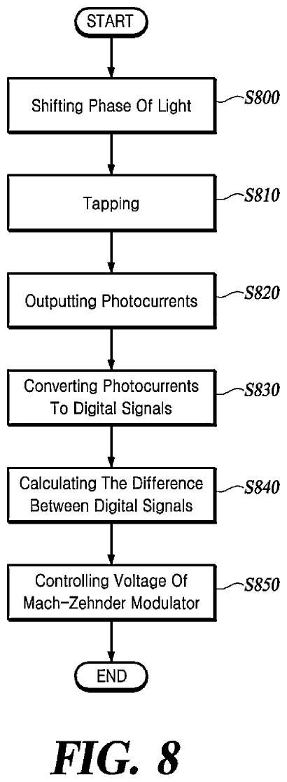

FIG. 8 is a flowchart of a method for controlling the voltage of the Mach-Zehnder modulator according to one embodiment of the present disclosure.

Referring to FIG. 8, when light enters the Mach-Zehnder modulator 100 from the light source through the waveguide, the Mach-Zehnder modulator 100 may shift the phase of the light. The Mach-Zehnder modulator 100 may make the phase-shifted light incident on the optical couplers 110 (S800).

The optical coupler 110 taps the incident light (S810). Light tapped by the optical couplers 110 may be incident on the photodetectors 120.

When light is incident, the photodetectors 120 may output photocurrents proportional to the optical power of the incident light (S820).

The analog-digital converters 140 may convert the photocurrents output from the photodetectors 120 to digital signals and input the digital signals to the subtractor 150 (S830).

The subtractor 150 may calculate the difference between the digital signals converted by the analog-digital converters 140 and transmit it to the modulator controller 160 (S840).

The modulator controller 160 controls the voltage of the Mach-Zehnder modulator 100 using the difference between the digital signals calculated by the subtractor 150.

The light source of the present disclosure may exist outside the silicon photonics optical transmitter. In this case, light incident from the light source may be incident using an optical fiber. The optical fiber may be connected to the coupling device and light may be transmitted to the Mach-Zehnder modulator 100 using the waveguide.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

According to one embodiment of the present disclosure, by adding photocurrents or photovoltages, it is possible to measure the optical power output from the light source, determine whether the light source is operating normally, and/or determine whether the light alignment between the light source and the silicon photonics is proper, regardless of the bias voltage of the Mach-Zehnder modulator and the structure of the silicon photonics.

According to another embodiment of the present disclosure, by subtracting photocurrents or photovoltages, it is possible to simply find the quadrature point, and monitor and control the operation of the optical modulator.

The features of the present disclosure are not limited to the features mentioned above, and other features not mentioned will be clearly understood by one of ordinary skill in the art from the above description.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A silicon photonics optical transmitter comprising:
a Mach-Zehnder modulator, including a 2×2 optical coupler, configured to receive light from a light source and modulate the received light;
a plurality of optical couplers configured to receive the modulated light output from the Mach-Zehnder modulator and tap the modulated light at a constant ratio;
a plurality of photodetectors configured to receive light tapped by the plurality of optical couplers and output photocurrents;
a plurality of analog-digital converters configured to convert the photocurrents output from the plurality of photodetectors to digital signals;
a monitor configured to measure an optical power based on a sum of photocurrents or photovoltages corresponding to the plurality of photodetectors; and
a modulator controller configured to control a voltage supplied to the Mach-Zehnder modulator based on a difference between the photocurrents or the photovoltages corresponding to the plurality of photodetectors.

2. The silicon photonics optical transmitter of claim 1, further comprising:
an adder configured to calculate a sum of the digital signals converted by the plurality of analog-digital converters; and
a subtractor configured to calculate a difference between the digital signals converted by the plurality of analog-digital converters,
wherein the monitor measures the optical power based on the calculated sum, and
wherein the modulator controller controls the voltage supplied to the Mach-Zehnder modulator based on the calculated difference.

3. The silicon photonics optical transmitter of claim 1, wherein:
a cathode of a first photodetector, selected from among the plurality of photodetectors, is connected to an anode of a second photodetector, selected from among the plurality of photodetectors;
cathodes or anodes of at least two third photodetectors, selected from among remaining photodetectors other than the first photodetector and the second photodetector, are connected to each other;
the monitor measures the optical power based on a digital signal corresponding to the at least two third photodetectors; and
the modulator controller controls the voltage supplied to the Mach-Zehnder modulator based on a digital signal corresponding to the first photodetector and the second photodetector.

4. The silicon photonics optical transmitter of claim 1, wherein the modulator controller is configured to control the voltage supplied to the Mach-Zehnder modulator to a quadrature point.

5. The silicon photonics optical transmitter of claim 1, further comprising a plurality of transimpedance amplifiers configured to receive the photocurrents output from the photodetectors and convert the photocurrents into the photovoltages,
wherein the plurality of analog-digital converters is configured to receive the photovoltages converted by the plurality of transimpedance amplifiers and convert the photovoltages to digital signals.

6. The silicon photonics optical transmitter of claim 1, wherein each of the plurality of optical couplers is a 1×2 optical coupler that taps an input light at a ratio of 1:9.

7. The silicon photonics optical transmitter of claim 1, further comprising an optical terminator configured to extinguish light tapped by at least one optical coupler selected from the plurality of optical couplers.

8. The silicon photonics optical transmitter of claim 1, further comprising a coupling device configured to output light tapped by at least one optical coupler selected from the plurality of optical couplers to an outside of the silicon photonics optical transmitter.

9. The silicon photonics optical transmitter of claim 1, wherein the Mach-Zehnder modulator further includes:
a 1×2 optical coupler configured to tap light incident from the light source;
at least two high speed phase shifters (HSPSs) configured to receive an RF electrical signal and modulate the light tapped by the 1×2 optical coupler; and
at least two low speed phase shifters (LSPSs) configured to receive a DC electrical signal and further modulate the light modulated by the HSPSs.

10. The silicon photonics optical transmitter of claim 1, wherein the light source is a light source contained inside a silicon photonics chip.

11. The silicon photonics optical transmitter of claim 1, wherein the light source is a light source outside a silicon photonics chip.

12. A method for a silicon photonics optical transmitter, the method comprising:
a modulating process of receiving light from a light source and shifting a phase of the light;
outputting the light modulated through the modulation process using a 2×2 optical coupler;
tapping the light output from the 2×2 optical coupler into a first portion and a second portion at a constant ratio;
outputting photocurrents using the first portion of the tapped light;
converting the photocurrents from analog signals to digital signals;
adding the digital signals together and monitoring the results;
calculating a difference between the digital signals; and
controlling the modulating process using the result of the calculating.

13. The method of claim 12, wherein the controlling includes controlling a voltage supplied to a Mach-Zehnder modulator, in the modulating process to be a quadrature point.

14. The method of claim 12, wherein the converting includes:
converting the photocurrents into photovoltages; and
converting the photovoltages from analog signals to digital signals.

15. The method of claim 12, wherein the tapping includes tapping an input light at a ratio of 1:9.

16. The method of claim 12, wherein the tapping includes tapping an input light at a ratio of 5:5.

17. The method of claim 12, further comprising:
extinguishing the second portion of the tapped light; and/or
outputting the second portion of the tapped light to an outside of the silicon photonics optical transmitter.

18. The method of claim 11, wherein the modulating process includes:
shifting, based on an RF electrical signal, the phase of light; and
further shifting, based on a DC electrical signal, the phase of the shifted light.

19. The method of claim 11, wherein the modulating process includes receiving light from a light source inside the silicon photonics optical transmitter.

20. The method of claim 11, wherein the modulating process includes receiving light from a light source outside the silicon photonics optical transmitter.
